(19) United States
(12) Patent Application Publication
(10) Pub. No.: US 2005/0170686 A1
(43) Pub. Date: Aug. 4, 2005

(54) Retractable cable system for personal computers

(76) Inventors: Miles K. Thorland, Fort Collins, CO (US); Nathan Dahl, Watford City, ND (US); Steve Olson, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/769,840

(22) Filed: Feb. 2, 2004

(51) Int. Cl. H01R 13/72

(52) U.S. Cl. 439/501

(57) ABSTRACT

A personal computer system having a retractable cable system or mechanism for use in connecting a first computing device to a second computing device. The retractable cable mechanism is disposed adjacent to a front panel of the either the first or second computing devices. The retractable cable mechanism is coupled to an extendable cable 26 that allows a user to interconnect the first and second computing devices using a cable that may be retracted inside of the personal computer when not in use.

### TECHNICAL FIELD

The present invention relates generally to personal computers, and cabling used therewith.

### BACKGROUND

The desktop space near a personal computer is often times cluttered which creates an unsightly mess as well as reduces a user's efficiency. Prior solutions have been to move peripheral device connectors from the back side of the personal computer to the front side. This was a major selling point for some personal computers when it was introduced and now has become a desirable feature. The disadvantage is that although it addresses the convenience factor of not having to get behind the personal computer to connect temporary cables to peripheral devices, it does not address the issue of clutter or providing a home for the cable when it is not attached the peripheral device.

It would be advantageous to reduce or eliminates the clutter associated with unused cables that attach to peripherals that are not permanently attached to the personal computer. It would also be advantageous to locate a cable after it has been stored by providing a consistent home for the cable.

U.S. Pat. No. 5,544,836 issued Aug. 13, 1996, entitled “Extensible and self-retractable cable device” discloses, in its Abstract, that an “extensible and self-retractable cable device is provided comprising, in one embodiment, a casing having winding cable, two reels, two spring housings, and two springs mounted within the casing. The device enables the manual withdrawal and automatic re-entry of a telephone cord connecting the handset to the base of a telephone set, thus, preventing the telephone cord from becoming crinkled and coiled up in an objectionable manner.

U.S. Pat. No. 6,424,369 issued Jul. 23, 2002, entitled “Hand-held computers incorporating reduced area imaging devices” discloses, in its Abstract, a “reduced area imaging device is provided for use with a miniature hand-held computer referred to in the industry as a PDA.” It is stated in U.S. Pat. No. 6,424,369 that “The camera module is of such small size that it can be easily stored within the housing of the PDA, and may be attached thereto as by a small retractable cable.”

U.S. Pat. No. 6,623,294 issued Sep. 23, 2003, entitled “Adapter with manually retractable cable assembly and electrical plug assembly” discloses, in its Abstract, an “electrical adapter having a manually retractable cable assembly where the electrical contacts of the retractable cable assembly are disposed along an axis of rotation to minimize the friction between the cable and contacts therein when the cable is extended and retracted. The electrical adapter includes a housing; an electrical plug assembly including an interchangeable module coupled to an adapter module, the interchangeable module having a plurality of prongs for receiving a first voltage when mated with an electrical receptacle, and a converter electrically coupled to the assembly for converting the first voltage into a second voltage; and a retractable cable assembly supported by the housing and electrically coupled to the converter. The retractable cable assembly includes a cable coupled at one end to an electrical plug for outputting the second voltage, a reel for winding and unwinding said cable, the reel being rotatably supported by the housing, a wheel mounted to the reel for enabling the cable to be manually dispensed from and retracted into the housing.” U.S. Pat. No. 6,402,546, assigned to the assignee of U.S. Pat. No. 6,623,294 discloses a similar device.

U.S. Pat. No. 5,708,262 issued Jan. 13, 1998, entitled “Miniature high speed scan element mounted on a personal computer interface card” discloses a “miniature high speed bar code scanning element is detachably mounted within an industry standard PCMCIA card for implementation in personal computing devices.” It is stated in the summary section of U.S. Pat. No. 5,708,262 that “The exteriorly mounted scanner head may be releasably attached to the PCMCIA card housing and electrically connected thereto by means of a semi-automatic retractable electrical cable, thus enabling selective detachment of the scanning head when desired by the user while maintaining electrical connectivity.” U.S. Pat. No. 6,036,098 issued Mar. 14, 2000 to the same inventor as U.S. Pat. No. 5,708,262 discloses a similar device.

U.S. Pat. No. 5,671,833 issued Sep. 30, 1997, entitled “Retractable coaxial cable device” discloses, in its Abstract, a “retractable device for mounting a length of high speed coaxial cable is taught. The device allows for easy connection of coaxial cable to various electronic devices while also being readily disconnected and stored as needed. The device comprises a compact housing containing a thin coaxial cable having connectors at each end. The cable can be dispensed from the housing as needed and then drawn back into the housing using an actuator, such as a crank handle, following use. The device is particularly effective for establishing temporary electronic signal connections, such as connecting a television to a cable television signal source or a computer to a computer network.”

U.S. Pat. No. 6,065,080 issued May 16, 2000, entitled Miniature circuit card with retractable cord assembly” discloses, in its Abstract, a “PCMCIA card includes a support, circuit components for providing faxmodem functions with respect to the support, a housing containing at least part of the support, a retractable cord mechanism at least partly contained in the housing for connecting the electronic component with an external device for communications therewith, the retractable cord mechanism including a cord and a storage mechanism for storing at least part of the cord in the housing, and a connector coupled to the cord for connecting to the external device. Alternate embodiments use optical or radio signal coupling from the PCMCIA card and all embodiments do not require a separate telephone connector to a telephone wall jack.”

However, none of the above-cited patents appear to disclose or suggest a personal computer having a retractable cable system adjacent its front surface or panel that is used to connect the personal computer to peripherals

### SUMMARY OF THE INVENTION

The present invention provides for a personal computer system having a retractable cable system or mechanism for use in connecting a first computing device to a second computing device. The retractable cable mechanism is disposed adjacent to and internal to a front panel of the first or second computing devices. This allows a user to interconnect the first or second computing devices by means of a cable that is preferably retracted inside of the personal computer when not in use.

### BRIEF DESCRIPTION OF THE DRAWINGS

The various features and advantages of embodiments of the present invention may be more readily understood with reference to the following detailed description taken in conjunction with the accompanying drawing figure, wherein like reference numerals designate like structural elements, and wherein:

FIG. 1 illustrates a front view of an exemplary embodiment of a personal computer system implemented in accordance with the principles of the present invention; and

FIG. 2 illustrates a partially cutaway side view of the exemplary personal computer system shown in FIG. 1.

### DETAILED DESCRIPTION

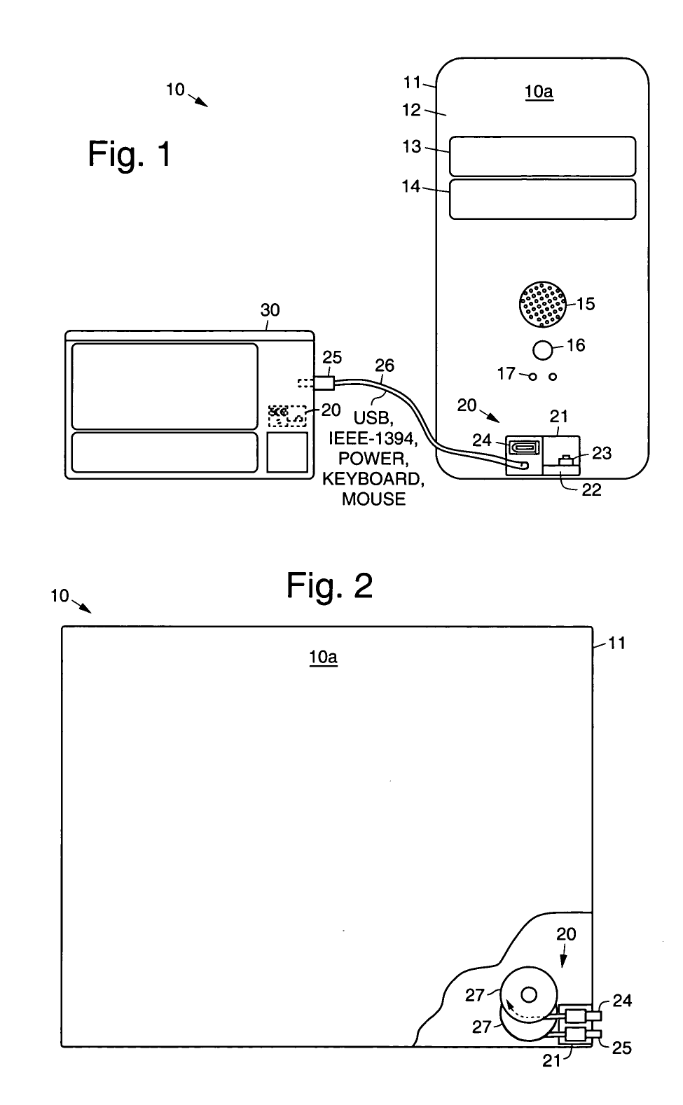

Referring to the drawing figures, FIG. 1 illustrates a front view of an exemplary embodiment of a personal computer system 10 in accordance with the principles of the present invention. FIG. 2 illustrates a partially cutaway side view of the exemplary personal computer system 10. In accordance with the present invention, the personal computer system 10 comprises a retractable cable system 20 for use in connecting an external peripheral device 30 (first computing device 30), such as a printer 30, for example to a personal computer 10a (second computing device 10a).

As is shown in FIG. 1, the personal computer 10a (second computing device 10a comprises an enclosure 11 having a front panel 12 or surface 12. The enclosure 11 is shown as housing, among other components, one or more CD-DVD drives 13, 14, a speaker 15, a power-on light 16 and one or more buttons 17 that reset the personal computer 10a, for example. Major internal components of the personal computer 10a are not shown.

In accordance with one aspect of the present invention, the retractable cable system 20 is disposed adjacent to and internal to the front panel 12 of the housing 11. The exemplary retractable cable system 20 shown in FIGS. 1 and 2 are designed to house and dispense two different types of cables 26. However, it is to be understood that many different types of cables may be used and the number of cables controlled by the retractable cable system 20 is a matter of design choice. In an alternative embodiment of the present invention, the retractable cable system 20 is disposed in the peripheral device 30 (first computing device 30), illustrated using dashed lines in FIG. 1.

The exemplary retractable cable system 20 comprises a housing 21 that captures two cable connectors 24, 25. Each cable connector 24, 25 is connected to its own cable 26 that extends through openings at the rear of the housing 21. Each cable 26 is coupled to a separate retractable cable mechanism 27 disposed within the housing 11 of the personal computer 10a. Each retractable cable mechanism 27 is a spring-loaded retraction device, winding mechanism, or reel, that reels in the cable 26 upon activation by a user. Such retractable cable mechanisms 27 are generally well-known in the art as is evidenced by the prior art patents cited in the Background section. FIG. 2 shows the cables 26 and their attached connectors 24, 25 retracted onto the spring-loaded retraction devices, or reels, or the respective retractable cable mechanisms 27.

The retractable cable mechanisms 27 are configured so that the cables 26 and attached connectors 24, 25 may be pulled away from the front surface 12 of the personal computer 10a to a desired length that allows each cable 26 to reach and be connected to a selected peripheral device 30. This is illustrated in FIG. 1.

The retractable cable devices disclosed in U.S. Pat. Nos. 5,544,836, 5,671,833, or 5,923,147, for example, cited in the Background section, may be adapted for use in the present invention. The contents of these U.S. Patents are incorporated herein by reference in their entirety. Thus, the retractable cable mechanism 13 may be similar to that disclosed in these patents, or similar in design to other patents cited in the Background section.

The cables 26 and connectors 24, 25 may comprise universal serial bus (U.S.B) or IEEE-1394 cable devices, for example. It is to be understood that other existing or to-be-developed cable and connector types may also be employed in the present invention. The cables 26 are preferably retracted into the housing when not in use. The length of each cable 26 may also be configured to extend from the personal computer 10a a specific length that allows connection to the external device 30. This helps to minimize desktop clutter.

Peripheral devices 30 employing U.S.B and IEEE-1394 connectors 24, 25 often times use more than one type of connector 24, 25 in connecting to the peripheral devices 30. Manufacturers have created adaptors 23 that translate from a standard size connector 24, 25 to a variety of mini or non-standard connector sizes. These adaptors are generally small in nature.

As is shown in FIG. 2, the retractable cable system 20 comprises a storage tray 22 that is accessible at the front of the personal computer system 10 by the user. The storage tray 22 is designed to hold or store cable adaptors 23, that convert from standard size connectors 24, 25 to a variety of mini or non-standard connector sizes. These adaptors 23 are generally small in nature.

The present retractable cable system 20 may also be used with other cables 26 such as power cords, keyboard cables, and mouse cables, and the like, as long as they are connected at the front side of the personal computer 10a or peripheral device 30.

The present invention eliminates clutter associated with unused cables 26 that are used to attach to peripheral devices 30 that are not permanently attached to the personal computer 10a. The present invention also provides for a storage location for the cables 26 after they have been used by providing a home for the cables 26.

Benefits of the present invention are that it allows the cables 26 to be just the right length when attached between a personal computer 10a and a peripheral device 30. The retractable cable mechanism 20 retracts the cables 26 when not in use, thus reducing desktop clutter. The housing 11 of the retractable cable mechanism 20 provides a storage location for the small adaptors 23 that convert between standard U.S.B or IEEE-1394 connectors and a variety of mini connectors.

The present invention thus provides a storage location for a cables 26 when they are retracted, and thus a user does not have to search for the cables 26 when they are needed. The present invention allows personal computer manufacturers to tout convenience and usability over its competitors, analogous to when cup holders or front side U.S.B and 1394 ports first became available.

Thus, a personal computer system having a front-side retractable cable system for use in connecting the personal computer to a peripheral device has been disclosed. It is to be understood that the above-described embodiment is merely illustrative of some of the many specific embodiments that represent applications of the principles of the present invention. Clearly, numerous and other arrangements can be readily devised by those skilled in the art without departing from the scope of the invention.

1. A personal computer system comprising:
a personal computer comprising:
an enclosure;
a retractable cable mechanism disposed in the enclosure adjacent to a front surface of the enclosure, for connecting the personal computer to a peripheral device, and that comprises:
a cable retraction mechanism;
a cable that is retractably attached to the cable retraction mechanism, said cable having an attached connector; and
and wherein the cable retraction mechanism dispenses the cable from the front surface of the enclosure to the peripheral device.

2. The system recited in claim 1 wherein the cable retraction mechanism is disposed in a housing.

3. The system recited in claim 1 wherein the retractable cable comprises a universal serial bus (U.S.B) cable.

4. The system recited in claim 1 wherein the retractable cable comprises an IEEE-1394 cable.

5. The system recited in claim 1 wherein the cable is configured to have a length that substantially extends from the personal computer to the external device.

6. The system recited in claim 1 wherein the cable comprises a standard size connector and the external device comprises a non-standard connector, and wherein the housing of the retractable cable mechanism houses one or more adaptors that translate from the standard size connector to the non-standard connector.

7. The system recited in claim 1 wherein the cable comprises a power cord that connects at the front side of the enclosure.

8. The system recited in claim 1 wherein the cable comprises a keyboard cable that connects at the front side of the enclosure.

9. The system recited in claim 1 wherein the cable comprises a mouse cable that connects at the front side of the enclosure.

10. Computing apparatus comprising:
a first computing device; and
a second computing device comprising:
an enclosure;
a retractable cable mechanism disposed in the enclosure adjacent to a front surface of the enclosure, for connecting the second computing device to the first computing device, and that comprises:
a cable retraction mechanism;
a cable that is retractably attached to the cable retraction mechanism, said cable having an attached connector; and
and wherein the cable retraction mechanism dispenses the cable from the front surface of the enclosure to the first computing device.

11. The system recited in claim 10 wherein the cable retraction mechanism is disposed in a housing.

12. The system recited in claim 10 wherein the retractable cable mechanism is disposed adjacent to a front surface of the enclosure.

13. The system recited in claim 10 wherein the retractable cable comprises a universal serial bus (U.S.B) cable.

14. The system recited in claim 10 wherein the retractable cable comprises an IEEE-1394 cable.

15. The system recited in claim 10 wherein the cable is configured to have a length that substantially extends from the second computing device to the first computing device.

16. The system recited in claim 10 wherein the cable comprises a standard size connector and the external device comprises a non-standard connector, and wherein the housing of the retractable cable mechanism houses one or more adaptors that translate from the standard size connector to the non-standard connector.

17. The system recited in claim 10 wherein the cable comprises a power cord that connects at the front side of the enclosure.

18. The system recited in claim 10 wherein the cable comprises a keyboard cable that connects at the front side of the enclosure.

19. The system recited in claim 10 wherein the cable comprises a mouse cable that connects at the front side of the enclosure.

20. Computing apparatus comprising:
a first computing device; and
a second computing device comprising:
an enclosure;
a retractable cable means disposed adjacent to a front surface of the enclosure, for interconnecting the first and second computing devices, and that comprises:
a housing;
cable retraction means disposed in the housing for dispensing the cable from the front surface of the enclosure; and
a cable having an attached connector that is retractably attached to the cable retraction means.
